(19) United States
(12) Patent Application Publication
(10) Pub. No.: US 2023/0000090 A1
(43) Pub. Date: Jan. 5, 2023

(54) AUTOMATED INJERA BAKING DEVICE

(71) Applicant: Sara Kebede Wordofa, Eagan, MN (US)

(72) Inventor: Sara Kebede Wordofa, Eagan, MN (US)

(21) Appl. No.: 17/856,341

(22) Filed: Jul. 1, 2022

Related U.S. Application Data
(60) Provisional application No. 63/218,126, filed on Jul. 2, 2021.

(51) Int. Cl. A21B 1/44; A21B 5/03; A21D 8/06

(52) U.S. Cl. CPC A21B 1/44; A21B 5/03; A21D 8/06

(57) ABSTRACT

An automated injera baking apparatus that includes a support frame, a rotating table housed within the support frame and having a circular rotating top surface that includes a plurality of injera cooking plates radially supported thereon, a burner assembly supported underneath the circular rotating top surface in a fixed condition, an injera batter pour system dispensing a pre-measured shot of injera batter in a generally round and flat configuration onto each injera cooking plate rotated underneath the batter pour system during the operation of the circular rotating top surface, a cover transfer arm repeatedly removing a cover from a cooking plate containing a cooked injera batter and transferring the cover onto one of the cooking plates containing the uncooked injera batter to assist in the shaping and even cooking of the uncooked injera batter, and an automated injera removal robotic arm located proximal the support frame.

### CROSS REFERENCE TO RELATED APPLICATIONS

This application claims priority to currently pending U.S. Provisional Application Ser. No. 63/218,126; filed on Jul. 2, 2021; titled AUTOMATED INJERA BREAD REMOVAL DEVICE.

### FIELD OF THE INVENTION

This invention relates generally to injera and, more specifically to an automated injera baking and stacking apparatus.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Injera is a well-known traditional Ethiopian spongy flatbread made using the flour from Teff grain. There are multiple steps that are involved in properly making authentic injera. For example, injera generally requires a batter mixture that has proper viscosity to retain leavening gasses (which are forms from the combination of air; water vapor or steam; carbon dioxide; and biological) while cooking. The injera batter should also be thin enough so as to result in a finished injera which is preferably one centimeter or less in thickness.

Injera traditionally has been cooked by independently pouring the injera batter onto the cooking plate by hand and placing the cooking plate on a stone oven. Once cooked, each injera is removed from the cooking plate by hand. Injera is normally patterned into a generally round and flat shape or configuration, much like a tortilla or a pancake. A cover may be placed over the injera batter cooking on a cooking plate to assist in the shaping and even cooking of the injera batter. With all of the required movements the injera cooking process is generally very taxing on the cook's body and requires a great deal of training and experience with the most experienced cooks having the capability of cooking around 100 injeras per hour.

The spongy texture of injera is preferably radially uniform and is preferably soft and flexible and has a unique brownish color. Some or all of these multiple requirements have prevented the successful automation of the injera production process.

The present invention is directed to an injera baking apparatus that applies certain features and/or processes of the traditional injera baking process and modernizing such process in order to automate and mass produce injera while requiring little to no experience or training to out cook the most experienced injera cookers or bakers.

### SUMMARY OF THE INVENTION

Briefly, the present invention comprises an automated injera baking apparatus having a support frame and a rotating table housed within the support frame. The rotating table includes a stand supporting a circular rotating top surface thereon and a motor assembly powering the circular rotation of the rotatable top surface with respect to the stand. The circular rotating top surface includes a plurality of removable injera cooking plate radially supported thereon in an equally spaced condition.

The automated injera baking apparatus includes a burner assembly supported underneath the circular rotating top surface in a fixed condition. The burner assembly having a plurality of heating burners continuously heating the injera cooking plates containing uncooked injera batter thereon during the operation of the circular rotating top surface with each of the heating plates containing the uncooked injera batter thereon maintaining a consistent injera batter cooking temperature during the rotation of the heating plates between heating burners.

The automated injera baking apparatus also includes an injera batter pour system connected to the support frame and a source of injera batter. The injera batter pour system includes a pour arm having a first end connected to a motor assembly and a second end having an injera batter dispensing nozzle connected thereto with the nozzle dispensing a pre-measured shot of injera batter in a generally round and flat configuration onto each injera cooking plate rotated underneath the nozzle of the batter pour system during the operation of the circular rotating top surface. In one embodiment of the present invention the cooking plate located underneath the nozzle of the batter pour system and a cooking plate containing a cooked injera batter are located adjacent each other and each lacking a heating burner located underneath.

The automated injera baking apparatus also includes an automated injera removal robotic arm located proximal the support frame having an injera transfer spatula connected to a free end of the injera removal robotic arm and a sensor to detect the presence of injera on the injera transfer spatula. The injera removal robotic arm replicating an operator's hand, wrist, and arm motion for the removal of the cooked injera from the cooking plate using a spatula and the stacking of the cooked injera onto a transfer pan.

The automated injera baking apparatus may further includes at least three covers each covering injera batter on a series of at least three different heating plates and a cover transfer arm assembly connected to the support frame with the cover transfer arm assembly repeatedly removing the cover from the cooking plate containing the cooked injera batter and transferring the cover onto one of the cooking top containing the uncooked injera batter to assist in the shaping and even cooking of the uncooked injera batter. The cover transfer arm assembly includes an elongated arm having a first end connected to a cover transfer arm motor and a second end having a cover grasping handle. A feature of the automated injera baking apparatus of the present invention is that the rotation of each heating plate from a batter loading position to an injera batter cooked and ready for removal position may be less than 8 seconds.

### BRIEF DESCRIPTION OF THE DRAWINGS

FIG. 1 is a perspective view showing an embodiment of an injera baking apparatus of the present invention;

FIG. 2 is a top view of an injera baking apparatus of FIG. 1;

FIG. 3 is a perspective view of a pouring system of the injera baking apparatus of FIGS. 1 and 2;

FIG. 3A is a top view showing injera batter dispensed or poured onto a heating plate;

FIG. 4 is a perspective view of an octagon burner of the injera baking apparatus of FIGS. 1 and 2;

FIG. 5 is a perspective view of a lid arm supporting a cooking cover thereon of the injera baking apparatus of FIGS. 1 and 2;

FIG. 6 is a skeletal view of a rotational table of the injera baking apparatus of FIGS. 1 and 2;

FIG. 7 is a partial view of the injera baking apparatus of FIGS. 1 and 2 in use;

FIG. 8 is a perspective view showing an embodiment of an automated injera removal arm that may be used with the of the injera baking machine of FIGS. 1 and 2; and

FIG. 9 is a partial view of the automated injera removal arm in use with the injera baking apparatus of FIGS. 1 and 2.

### DESCRIPTION OF THE PREFERRED EMBODIMENT

The general purpose of the present invention, which will be described subsequently in greater detail, is to provide an injera baking apparatus to automate and mass produce the injera baking process.

There has thus been outlined the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the disclosing subject matter be regarded as including such equivalent constructions insofar as they do not depart from the spirit and scope of the present invention.

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

In addition, the accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of any potential claims.

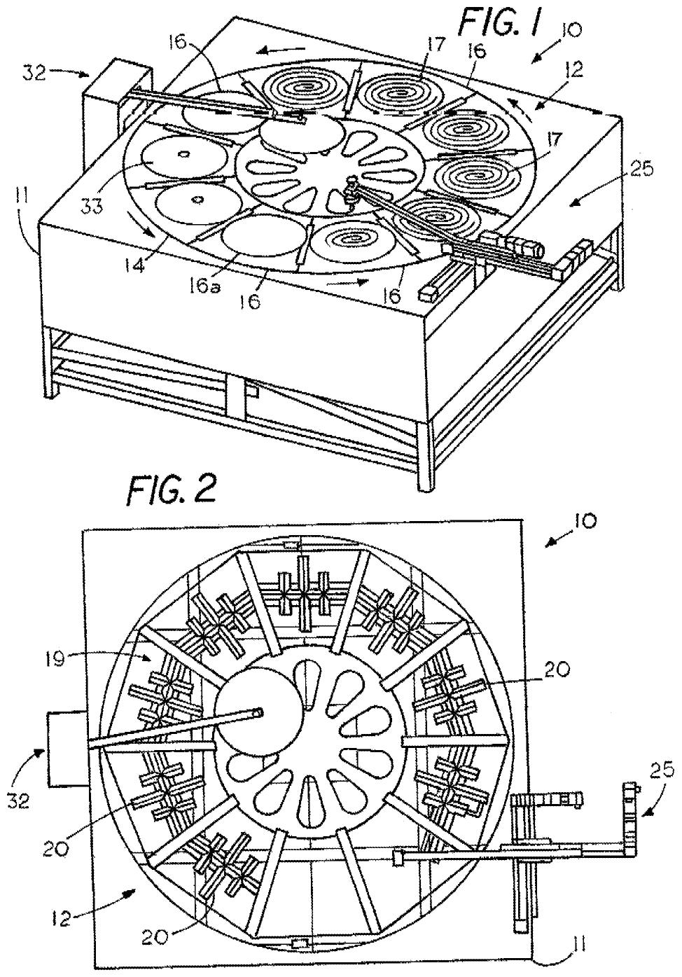

The present invention is directed to an injera baking apparatus that applies certain features and/or processes of the traditional injera baking process and modernizing such process in order to automate and mass produce injera while retaining the hand-made characteristics of traditional injera. Referring to the drawings, FIG. 1 is a perspective view and FIG. 2 is a top view showing an embodiment of an injera baking apparatus 10 of the present invention, which generally comprises a frame 11 supporting or housing a rotating table 12 therein.

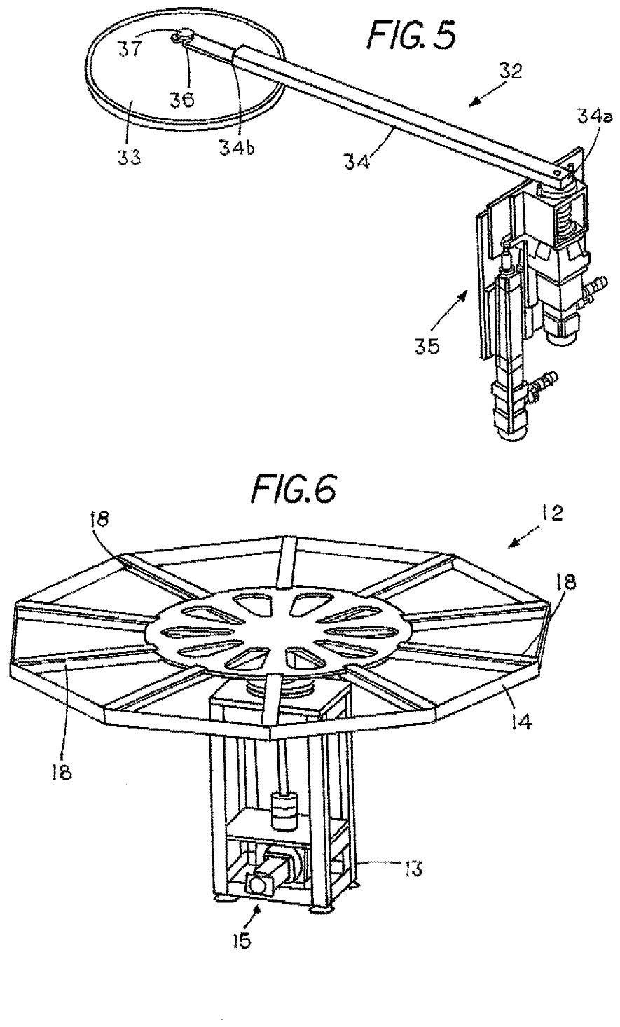

FIG. 6 is a skeletal view showing the rotational table 12 of the injera baking apparatus 10 of FIGS. 1 and 2, which generally includes a stand 13 supporting a circular rotating top surface 14 thereon and a motor assembly 15 powering the circular rotation of the rotatable top surface 14 with respect to the stand 13.

In the embodiment of FIG. 1 the circular rotating top surface 14 is shown including a plurality of preferably removable injera cooking plates 16 radially supported thereon in an equally spaced condition. Each of the injera cooking plates 16 of FIG. 1 are shown including a circular-shaped injera batter receiving surface 16a for receiving a pre-measured volume or shot of injera batter 17 thereon in a generally round and flat configuration.

Although the FIGS. 2 and 6 shown the rotatable top surface 14 of the rotational table 12 having a plurality of segmented railings 18 for radially supporting the injera cooking plates 16 to the circular rotating top surface 14, alternative embodiments of the present invention may include other type mechanisms or devices for radially supporting the injera cooking plates 16 to the circular rotating top surface 14. In addition, although alternative embodiments of the present invention may include a circular rotating top surface having less than ten injera cooking plates 16 or more than ten injera cooking plates 16 radially supported on the circular rotating top surface in an equally spaced condition, the embodiment of FIG. 1 shows the circular rotating top surface 14 having ten injera cooking plates 16 radially supported on the circular rotating top surface in an equally spaced condition.

The injera baking apparatus 10 is also shown having a burner assembly such as an octagonal-shaped burner assembly 19 supported underneath the circular rotating top surface in a fixed condition. FIG. 4 is a close-up perspective view of showing the octagonal-shaped burner assembly 19 of the injera baking apparatus of FIG. 2, which includes a plurality of individual heating burners 20 and more specifically eight individual heating burners 20 supported on a burner base 21. The burner base 21 functions to continuously heat and maintain a consistent injera batter cooking temperature to each of the injera cooking plates 16 containing the uncooked injera batter thereon during the operation of the injera baking apparatus 10. In the embodiment of FIG. 4, the octagonal-shaped burner assembly 19 is shown including a controller box 22 connected to the burner base 21 to allow the user to adjust various setting for the octagonal-shaped burner assembly 19. The octagonal-shaped burner assembly 19 is shown also shown including a gas mix chamber 23 and a fire monitor device 24 connected to the burner base 21.

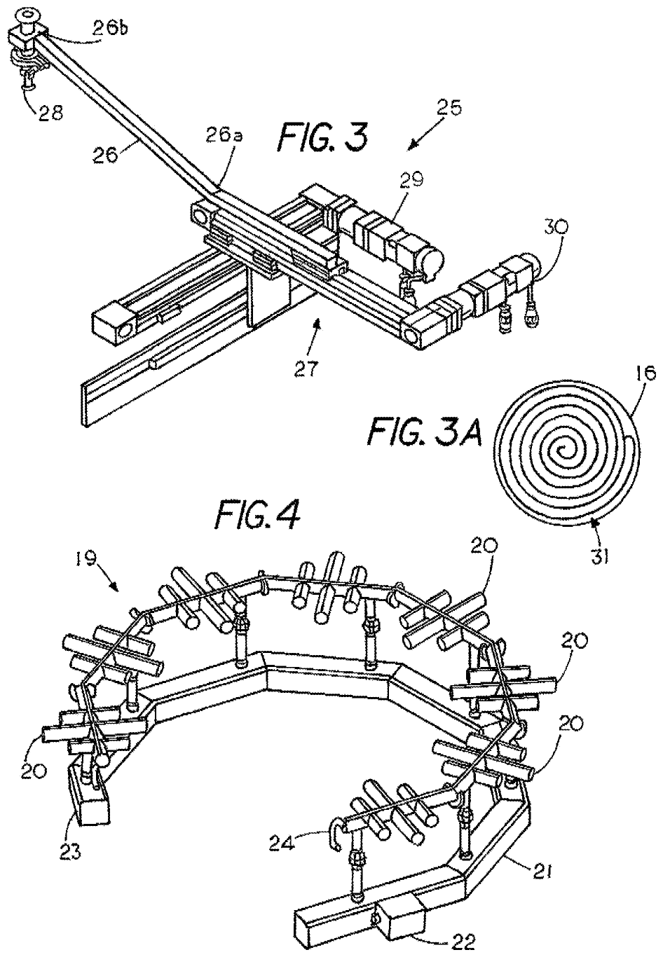

The injera baking apparatus 10 also includes an injera batter pour system 25 connected to the frame 11 and a source of injera batter (not shown). FIG. 3 is a close-up perspective view of the injera batter pour system 25 of the injera baking apparatus 10 of FIGS. 1 and 2, which generally includes a pour arm 26 having a first end 26a connected to a motor assembly 27 and a second end 26b having an injera batter dispensing nozzle 28 connected thereto. The batter dispensing nozzle 28 dispensing or distributing the pre-measured shot of injera batter 17 in a generally round and flat configuration onto each injera cooking plate 16 that is rotated underneath the batter dispensing nozzle 28 of the batter pour system 25 during the operation the injera baking apparatus 10.

In the embodiment of FIG. 3, the motor assembly 27 of the injera batter pour system 25 is shown including a belt drive system 29 and a drive motor 30 to facilitate the injera batter dispensing nozzle 28's specific and pre-set movement with respect to the cooking plate 16 in the dispensing of the injera batter 17 onto the cooking plate 16 in the generally round and flat configuration. FIG. 3A is a top view showing an example of an injera batter dispensing or pouring pattern 31 on the cooking plate 16.

The injera baking apparatus 10 of FIG. 1 further includes a cover transfer arm 32 connected to the support frame 11. FIG. 5 is a close-up perspective view of the cover transfer arm 32 supporting a cooking cover 33 thereon of the injera baking apparatus of FIGS. 1 and 2. In general, the cover transfer arm 32 operates to repeatedly remove the cover 33 from the cooking plate 16 containing a cooked injera batter and transferring the cover 33 onto one of the cooking plates containing the uncooked injera batter to assist in the shaping and even cooking or baking of the uncooked injera batter. The cover transfer arm 32 includes an elongated arm 34 having a first end 34a connected to a cover transfer arm motor assembly 35 and a second end 34b having a cover grasping mechanism. In the embodiment of FIG. 5, the cover grasping mechanism of the cover transfer arm 32 is shown as comprising a cover knob grasping slot 36 which functions to engage and maintain a transfer supporting hold to a knob handle 37 of cover 33.

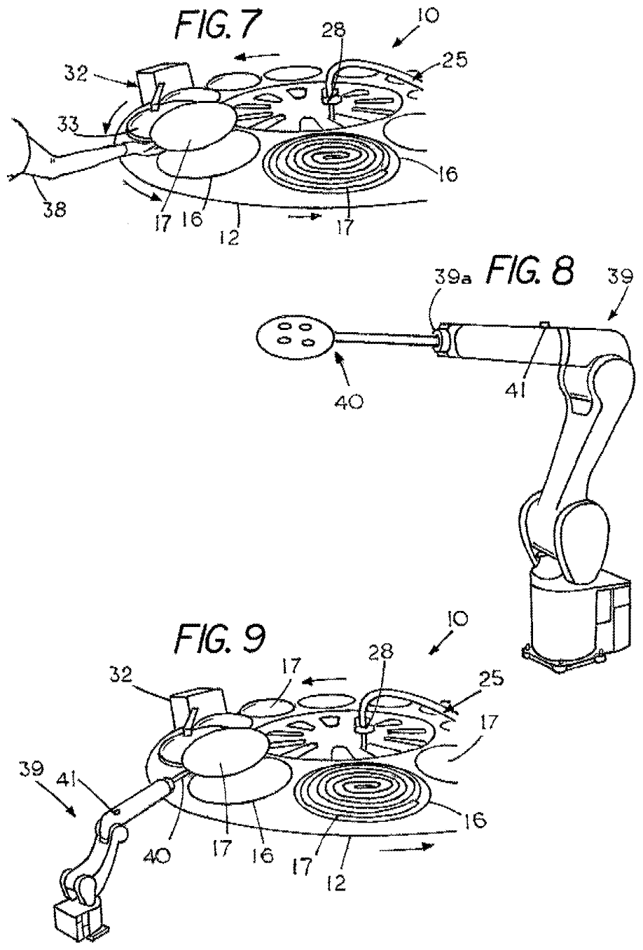

As shown in FIGS. 1 and 7, for injera baking apparatus 10 having eight to ten cooking plate 16, at least three covers 33 may be used to independently cover uncooked injera batter 17 on a series of at least three different heating plates 16.

FIG. 7 is a partial view of the injera baking apparatus 10 of FIGS. 1 and 2 in use, which starts with the injera batter pour system 25 dispensing a pre-measured volume or shot of injera batter 17 onto the circular-shaped injera batter receiving surface 16a of the injera cooking plate 16 after which the loaded the injera cooking plate 16 starts the cooking or baking process of the injera batter through the automated rotation of the injera cooking plate 16 in a counterclockwise direction over each burner of the set of eight burners 20 of the octagonal-shaped octagonal shaped burner assembly 19.

A feature of the present invention is that the rotation of each heating plate 16 of the automated injera baking apparatus 10 from a batter loading position to an injera batter cooked and ready for removal position precision timed and may be a quick as less than 8 seconds thereby enabling the baker to more than triple the output of the most experienced traditional injera bakers by baking as many as 300 to 350 traditional hand back quality injera per hour without requiring a great deal of training and experience since the main responsibility of the baker 38 is to remove the injera from the cooking plate 16 once the injera is done baking. The automated injera baking apparatus 10 also provide less stress on the baker's body such as the baker's muscles since it eliminates the injera batter load process.

After the loaded injera cooking plate 16 passes over the final burner of the set of eight burners 20, the injera batter 17 supported on the cooking plate 16 is done baking and may then be removed from the cooking plate 16 by the operator or baker 38 by hand through the use of a spatula. The empty cooking plate 16 is then reloaded with another shot of injera batter 17 onto the circular-shaped injera batter receiving surface 16a of the injera cooking plate 16 by the injera batter pour system 25 and the counterclockwise rotational cooking process is then repeated.

It is noted that although the automated injera baking apparatus 10 is shown in the drawings as having counterclockwise rotational cooking process, alternative embodiments of the present invention may include an automated injera baking apparatus having clockwise rotational cooking process, depending on the baker's preferences.

Referring to FIGS. 1 and 2, it is noted that in the embodiment of the injera baking apparatus 10 the cooking plate 16 containing the cooked injera batter 17 and the cooking plate 16 located underneath the nozzle 28, ready for reloading of the injera batter 17 by of the batter pour system 25, are located adjacent each other and each lacks a heating burner 20 located underneath their cooking plate 16. That is, the aforementioned two cooking plates 16 are not heated by burners 20.

In order to assist in the shaping and even baking of the uncooked injera batter, the cover 33 is placed over the uncooked injera batter supported by the cooking plate 16 during part of the cooking process by the cover grasping mechanism 36 of the cover transfer arm 32.

In the embodiment of FIG. 1 the cover 33 is maintained over the uncooked injera batter 17 for the rotational travel of the cooking plate 16 over at least 3 or 4 burners after which the injera batter 17 done baking and the cover transfer arm 32 removes the cover 33 from the cooking plate 16.

FIG. 8 is a perspective view showing an embodiment of an automated injera removal robotic arm 39 that may be used in conjunction with the of the injera baking apparatus 10 of FIGS. 1 and 2 to replace the need for human hand removal of the injera 17 from the injera baking apparatus 10 as shown in FIG. 7. The automated injera removal robotic arm 39 is designed to remove the cooked injera 17 from the cooking plates 16 of the injera baking apparatus 10 and stack them onto transfer pans such as transfer pans supported on an inline conveyor belt or a conveyor belt system, preferably in stacks, such as stacks of ten each.

The transfer pans are preferably portable and may be moved from the conveyor to the packaging tables, and back to the conveyor. In one embodiment of the present invention the motorized conveyor will move the transfer pans into a placement zone of the automated injera removal robotic arm 39 with the automated injera removal robotic arm 39 and the motorized conveyor preferably fully guarded for personal protection.

As shown in the embodiment of FIG. 8, the injera removal robotic arm 39 includes an injera transfer tool such as injera transfer spatula 40 connected to a free end 39a of the injera removal robotic arm 39.

One of the features of the automated injera removal robotic arm 39 is that the automated injera removal robotic arm 39 functions to replicate the motion of an operator's hand, wrist, and arm motions to reproduce the injera handling process. More specifically, the injera removal robotic arm 39 replicates an operator's hand, wrist, and arm motion for the removal of the cooked injera from the cooking plate using a spatula and the stacking of the cooked injera onto a transfer pan. The aforementioned, preferably may accomplished in a total cycle time between bread picks based on 8 seconds for each cycle. One of the ways to accomplished the aforementioned is to provide the injera removal robotic arm 39 with 6-Axis motion capabilities, namely motion in a fore-and-aft axis, a lateral axis, a vertical axis, a roll rotational axis, a pitch rotational axis, and a yaw rotational axis.

FIG. 9 is a partial view showing the automated injera removal robotic arm 39 of FIG. 8 in use with the injera baking apparatus 10 of FIGS. 1 and 2. In use of embodiment of FIG. 8, the injera transfer spatula 40 of the automated injera removal robotic arm 39, which may be a custom stainless-steel spatula, is used to remove the cooked injera 17 from the cook plate 16. The automated injera removal robotic arm 39 may include a sensor 41 used to detect the presence of the cooked injera 17 on the spatula 40. After removing the cooked injera 17 from the cook plate 16, the automated injera removal robotic arm 39 will stack the injera 17 onto the transfer pan located on the conveyor and within the safety guarding zone.

After stacking, the spatula 40 will return to the home position to prepare for removal of the next cooked injera 17. The inline conveyor may be fabricated from stainless steel with plastic flat chain links which are easily cleaned. In some embodiments of the present invention twelve (12) Transfer Pans may be used to transfer stacks of ten (10) injera 17 pieces and ten (10) gauge stainless steel Transfer Pans may be used to place cooked injera 17, then when ten (10) pieces of injera 17 have been stacked, the conveyor will move the stacked Transfer Pan out from below a guarding where the operator may remove the Transfer Pan with the ten (10) stacked injeras 17 and place it onto a worktable.

The ten-piece stack of injeras 17 may then be removed from the Transfer Pan for packing. The Transfer Pan may be placed back onto the conveyor. The Transfer Pan may include three (3) small standoffs on a bottom of the pan so the pan may be easily lifted off a flat surface with the small standoffs used to locate the Transfer Pan to the conveyor surface.

In some embodiments of the present invention the conveyor may be of modular construction to allow for lengthening the conveyor in the future and will have a total of eighteen (18) stations on the top and bottom surfaces. Eight (8) stations will be available on the top surface of the conveyor for Transfer Plates. The conveyor may index around eighteen (18) inches in one direction to move the Transfer Pans as they complete each stack. The present invention may also include an electrical encoder to keep track of a distance the conveyor travels with each index and the conveyor may be supported by adjustable leveling pads.

The conveyor may also include casters mounted near the conveyor leveling pads. Raising the leveling pads up into the legs will allow the casters to contact the floor so the conveyor can be moved for cleaning.

The frame of the automated injera removal robotic arm 39 may be fabricated from but not limited to wall steel tubing such as but not limited to 2″×2×¼″ wall steel tubing and epoxy painted and supported by adjustable leveling pads. The frame of the automated injera removal robotic arm 39 may also be attached to a cooker for location and registration to the cooking plate 16.

In the embodiment of FIG. 8 the automated injera removal robotic arm 39 may be fully guarded such as with an aluminum extrusion frame and ¼″ thick clear Lexan Polycarbonate with three doors allowing access from the front, end, and backside of the guarding. The guarding may surround the automated injera removal robotic arm 39 on all sides and the bottom and stainless-steel panels will be used directly over the cook area.

An opening in the bottom of the guarding may be provided for a trash bin used by the robot on startup and shut down sequences. An FDA approved stationary brush may be mounted above the trash bin where the automated injera removal robotic arm 39 may swipe the spatula surface across the brush to maintain a clean surface. Debris from the brush can fall into the trash bin.

Optional door switches may be safety interlocked to prevent opening during movement of the automated injera removal robotic arm 39. The automated injera removal robotic arm 39 may be cycle stopped to provide access the guard doors. The automated injera removal robotic arm 39 may also include a three-color machine function light mounted above the guarding to provide user indication regarding the current status of the automated injera removal robotic arm 39. The present invention may also include two sets of basic machine function switches and various indicators that functions to control the automated injera removal robotic arm 39, one on the cook side of the conveyor, and one on the pack side of the conveyor.

I claim:

1. An automated injera baking apparatus comprising:
a support frame;
a rotating table housed within the support frame, the rotating table including a stand supporting a circular rotating top surface thereon and a motor assembly powering the circular rotation of the rotatable top surface with respect to the stand, the circular rotating top surface having a plurality of injera cooking plates radially supported thereon in an equally spaced condition;
a burner assembly supported underneath the circular rotating top surface in a fixed condition, the burner assembly having a plurality of individual heating burners continuously heating the injera cooking plates containing the uncooked injera batter thereon during the operation of the circular rotating top surface;
an injera batter pour system connected to the support frame and a source of injera batter, the injera batter pour system including a pour arm having a first end connected to a motor assembly and a second end having an injera batter dispensing nozzle connected thereto, the nozzle dispensing a pre-measured shot of injera batter in a generally round and flat configuration onto each injera cooking plate rotated underneath the nozzle of the batter pour system during the operation of the circular rotating top surface;
a cover transfer arm connected to the support frame, the cover transfer arm repeatedly removing a cover from a cooking plate containing a cooked injera batter and transferring the cover onto one of the cooking plates containing the uncooked injera batter to assist in the shaping and even cooking of the uncooked injera batter, the cover transfer arm including an elongated arm having a first end connected to a cover transfer arm motor assembly and a second end having a cover grasping mechanism; and
an automated injera removal robotic arm located proximal the support frame, the injera removal robotic arm including an injera transfer tool connected to a free end of the injera removal robotic arm, the injera removal robotic arm replicating an operator's hand, wrist, and arm motion for the removal of the cooked injera from the cooking plate using a spatula and the stacking of the cooked injera onto a transfer pan.

2. The automated injera baking apparatus of claim 1 wherein the injera transfer tool comprises an injera transfer spatula.

3. The automated injera baking apparatus of claim 1 including an injera transfer pan supporting inline conveyor belt.

4. The automated injera baking apparatus of claim 1 wherein the injera removal robotic arm includes provide motion in a fore-and-aft axis, a lateral axis, a vertical axis, a roll rotational axis, a pitch rotational axis, and a yaw rotational axis

5. The automated injera baking apparatus of claim 1 wherein the injera removal robotic arm includes a sensor to detect the presence of injera on the injera transfer tool.

6. The automated injera baking apparatus of claim 1 wherein the motor assembly of the injera batter pour system includes a belt drive system and a drive motor to facilitate the nozzle's dispensing of the injera batter onto the cooking plate in the generally round and flat configuration.

7. The automated injera baking apparatus of claim 1 wherein the cover grasping mechanism of the cover transfer arm comprises a cover knob grasping slot.

8. The automated injera baking apparatus of claim 1 including at least three covers each covering uncooked injera batter on a series of at least three different heating plates.

9. The automated injera baking apparatus of claim 1 wherein the cooking plate containing the cooked injera batter and the cooking plate located underneath the nozzle of the batter pour system are located adjacent each other and each lacks a heating burner located underneath.

10. The automated injera baking apparatus of claim 1 wherein each of the heating plates maintains a consistent injera batter cooking temperature during the rotation of the heating plates between heating burners.

11. An automated injera baking apparatus comprising:
a support frame;
a rotating table housed within the support frame, the rotating table including a stand supporting a circular rotating top surface thereon and a motor assembly powering the circular rotation of the rotatable top surface with respect to the stand, the circular rotating top surface having ten removable injera cooking plate radially supported thereon in an equally spaced condition;
a burner assembly supported underneath the circular rotating top surface in a fixed condition, the burner assembly having a plurality of individual heating burners continuously heating the injera cooking plates containing the uncooked injera batter thereon during the operation of the circular rotating top surface;
an injera batter pour system connected to the support frame and a source of injera batter, the injera batter pour system including a pour arm having a first end connected to a motor assembly and a second end having an injera batter dispensing nozzle connected thereto, the nozzle dispensing a pre-measured shot of injera batter in a generally round and flat configuration onto each injera cooking plate rotated underneath the nozzle of the batter pour system during the operation of the circular rotating top surface;
a cover transfer arm connected to the support frame, the cover transfer arm repeatedly removing a cover from a cooking plate containing a cooked injera batter and transferring the cover onto one of the cooking plates containing the uncooked injera batter to assist in the shaping and even cooking of the uncooked injera batter, the cover transfer arm including an elongated arm having a first end connected to a cover transfer arm motor assembly and a second end having a cover grasping mechanism; and
an automated injera removal robotic arm located proximal the support frame, the injera removal robotic arm including an injera transfer spatula connected to a free end of the injera removal robotic arm, the injera removal robotic arm including a sensor to detect the presence of injera on the injera transfer spatula, the injera removal robotic arm replicating an operator's hand, wrist, and arm motion for the removal of the cooked injera from the cooking plate using a spatula and the stacking of the cooked injera onto a transfer pan.

12. The automated injera baking apparatus of claim 11 wherein the motor assembly of the injera batter pour system includes a belt drive system and a drive motor to facilitate the nozzle's dispensing of the injera batter onto the cooking plate in the generally round and flat configuration.

13. The automated injera baking apparatus of claim 12 wherein the burner assembly includes a burner base, a controller box connected to the burner base and a gas mix chamber connected to the burner base, and a fire monitor device connected to the burner base.

14. The automated injera baking apparatus of claim 13 including at least three covers each covering uncooked injera batter on a series of at least three different heating plates.

15. The automated injera baking apparatus of claim 14 wherein the cooking plate containing the cooked injera batter and the cooking plate located underneath the nozzle of the batter pour system are located adjacent each other and each lacks a heating burner located underneath.

16. The automated injera baking apparatus of claim 15 wherein each of the heating plates maintains a consistent injera batter cooking temperature during the rotation of the heating plates between heating burners.

17. The automated injera baking apparatus of claim 16 wherein the plurality of injera cooking plates comprises ten injera cooking plates radially supported on the circular rotating top surface in an equally spaced condition.

18. The automated injera baking apparatus of claim 17 wherein the circular rotating top surface comprises a counterclockwise rotating top surface.

19. The automated injera baking apparatus of claim 18 wherein the rotation of each heating plate from a batter loading position to an injera batter cooked and ready for removal position is less than 8 seconds.

20. An automated injera baking apparatus comprising:
a support frame;
a rotating table housed within the support frame, the rotating table including a stand supporting a circular rotating top surface thereon and a motor assembly powering the circular rotation of the rotatable top surface with respect to the stand, the circular rotating top surface having ten removable injera cooking plate radially supported thereon in an equally spaced condition;
a burner assembly supported underneath the circular rotating top surface in a fixed condition, the burner assembly having eight individual heating burners continuously heating the injera cooking plates containing uncooked injera batter thereon during the operation of the circular rotating top surface with each of the heating plates containing the uncooked injera batter thereon maintaining a consistent injera batter cooking temperature during the rotation of the heating plates between heating burners;
an injera batter pour system connected to the support frame and a source of injera batter, the injera batter pour system including a pour arm having a first end connected to a motor assembly and a second end having an injera batter dispensing nozzle connected thereto, the nozzle dispensing a pre-measured shot of injera batter in a generally round and flat configuration onto each injera cooking plate rotated underneath the nozzle of the batter pour system during the operation of the circular rotating top surface, the cooking plate located underneath the nozzle of the batter pour system and a cooking plate containing a cooked injera batter located adjacent each other and each lacking a heating burner located underneath;
at least three covers each covering injera batter on a series of at least three different heating plates;
a cover transfer arm connected to the support frame, the cover transfer arm repeatedly removing the cover from the cooking plate containing the cooked injera batter and transferring the cover onto one of the cooking plates containing the uncooked injera batter to assist in the shaping and even cooking of the uncooked injera batter, the cover transfer arm including an elongated arm having a first end connected to a cover transfer arm motor assembly and a second end having a cover grasping mechanism; and
an automated injera removal robotic arm located proximal the support frame, the injera removal robotic arm including an injera transfer spatula connected to a free end of the injera removal robotic arm, the injera removal robotic arm including a sensor to detect the presence of injera on the injera transfer spatula, the injera removal robotic arm replicating an operator's hand, wrist, and arm motion for the removal of the cooked injera from the cooking plate using a spatula and the stacking of the cooked injera onto a transfer pan.
